(19) United States
(12) Patent Application Publication
(10) Pub. No.: US 2012/0159434 A1
(43) Pub. Date: Jun. 21, 2012

(54) CODE CLONE NOTIFICATION AND ARCHITECTURAL CHANGE VISUALIZATION

(75) Inventors: Yingnong Dang, Beijing (CN); Sadi Khan, Redmond, WA (US); Dongmei Zhang, Bellevue, WA (US); Weipeng Liu, Beijing (CN); Song Ge, Beijing (CN); Gong Cheng, Beijing (CN)

(73) Assignee: Microsoft Corporation, Redmond, WA (US)

(21) Appl. No.: 12/972,535

(22) Filed: Dec. 20, 2010

(51) Int. Cl. G06F 9/44

(52) U.S. Cl. 717/120

(57) ABSTRACT

A code verification system is described herein that provides augmented code review with code clone analysis and visualization to help software developers automatically identify similar instances of the same code and to visualize differences in versions of software code over time. The system uses code clone search technology to identify code clones and to present the user with information about similar code as the developer makes changes. The system may provide automated notification to the developer or to other teams as changes are made to code segments with one or more related clones. The code verification system also helps the developer to understand architectural evolution of a body of software code. The code verification system provides an analysis component for determining architectural differences based on the code clone detection result between the two versions of the software code base. The code verification system also provides a user interface component for displaying identified differences to developers and others involved with the software development process in intuitive and useful ways.

### BACKGROUND

The software development process at its simplest level involves a software developer writing software code in a language (e.g., C++, C#, Assembly), and using tools such as compilers to build the code into binary executable modules. As software becomes more complex, multiple developers may work on a project and use tools that are more sophisticated such as check-in managers, centralized build systems, and so forth. Teams may also institute processes, such as peer reviews that occur at the architectural and source code levels. A popular process is to have at least one developer other than the main developer review each check-in. A developer may also run one or more automated verification tools, such as unit tests, static code checkers, runtime code checkers, and so forth. Newer integrated development environments (IDEs), such as MICROSOFT™ VISUAL STUDIO™ attempt to inform developers as early as possible about potential code defects. For example, the IDE may parse software code as the developer types the code to identify misspellings, referenced variables that have not been declared, and so forth.

Code reuse is commonly encouraged to avoid “reinventing the wheel” to solve each new problem. Software code that has been used for a long time is more likely to be more defect free as the code has likely received more coverage and analysis over time. In addition, many software problems present themselves repeatedly such that reusing code allows solving old problems using known good practices and allowing developers to focus on new problems or software code that is specific to a particular project. Code reuse can occur on a small scale, where a developer uses similar code multiple times for the same project, but can also occur on a larger scale, where a developer working on one project at a company reuses code from another project at the company. The two developers may not work on the same team or ever communicate with each other to know about the reused code.

One problem with code reuse is that it also leads to bug propagation. A software defect in code that is copied (called a clone herein) will be present in all of the instances of the code. Where developers copy code across a company or even more broadly, a developer fixing a defect in one project may not be aware of the other projects where the defect might exist. This leads to each team using duplicate effort to find and fix problems, or worse a problem that is known and fixed on one team not getting fixed on another where code was reused. During code reviews today, a reviewer is limited to the clones within his/her own knowledge and may not know about all clones that carry the same defect fixed in the current instance. It is difficult to guarantee that all cloned copies are considered. Another problem is that software code evolves over time in ways that are difficult to visualize, particularly where multiple developers work on the code over time. A developer making a change may want to understand architectural differences between two versions of the source code. For example, the class level, namespace level, or module level differences for a code base may be complex and difficult to grasp digging through many source files at the same time.

### SUMMARY

A code verification system is described herein that provides augmented code review with code clone analysis and visualization to help software developers automatically identify similar instances of the same code and to visualize differences in versions of software code over time. The system uses code clone search technology to identify code clones and to present the user with information about similar code as the developer makes changes. The system may provide automated notification to the developer or to other teams as changes are made to code segments with one or more related clones. The code verification system also helps the developer to understand architectural evolution of a body of software code. The code verification system provides an analysis component for determining architectural differences and a user interface component for displaying identified differences to developers and others involved with the software development process in intuitive and useful ways. This may help the developer to understand the reasons for a change or to spot bad architectural changes before they go too far. The system may provide similar visualization for code clones to allow a developer to visualize differences between one clone and another. This allows reviewers to analyze and visualize architectural level differences between two versions of a code base, provides intuitive understanding of architectural level differences, and improves the efficiency of architecture-level code review. Thus, the code verification system increases code correctness and reduces the cost of errors by avoiding duplicate effort from undetected code clones with defects that have been previously fixed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the code verification system, in one embodiment.

FIG. 2 is a flow diagram that illustrates processing of the code verification system to notify a software developer that software code exists related to software code the developer is modifying, in one embodiment.

FIG. 3 is a flow diagram that illustrates processing of the code verification system to display architectural level changes to a software developer related to changes in software code, in one embodiment.

FIG. 4 is a display diagram that illustrates a user interface displayed by the code verification system for notifying a software developer about code clones, in one embodiment.

FIG. 5 is a display diagram that illustrates a user interface displayed by the code verification system for providing a visualization of architectural changes to software code to a software developer, in one embodiment.

### DETAILED DESCRIPTION

A code verification system is described herein that provides augmented code review with code clone analysis and visualization to help software developers automatically identify similar instances of the same code and to visualize differences in versions of software code over time. The system uses code clone search technology described previously (see, e.g., U.S. patent application Ser. No. 12/752,942, filed Apr. 1, 2010, and entitled “CODE-CLONE DETECTION AND ANALYSIS”) to identify code clones and to present the user with information about similar code as the developer makes changes. For example, the system may provide a tooltip popup or window that displays locations with similar software code as a developer makes changes to a block of code. At a coarser level, the system may provide automated notification to the developer or to other teams as check-ins are made to code segments for which their code includes one or more clones. The system can identify cloned copies of a piece of code to be changed and suggest to the code reviewer to check cloned copies for potential application of the same changes.

The code verification system also helps the developer to understand architectural evolution of a body of software code. For example, a software architect may want to understand architecture evolution between two milestones (e.g., M1 and M2) of a project. As another example, a developer conducting a code branch integration between two source control branches may want to understand the architecture level difference between the source code in the two branches. The code verification system provides an analysis component for determining architectural differences and a user interface component for displaying identified differences to developers and others involved with the software development process in intuitive and useful ways. This may help the developer to understand the reasons for a change or to spot bad architectural changes before they go too far. The system may provide similar visualization for code clones to allow a developer to visualize differences between one clone and another. This allows reviewers to analyze and visualize architectural level differences between two versions of source code of a code base, provides intuitive understanding of architectural level differences, and improves the efficiency of architecture level code review. Thus, the code verification system increases code correctness and reduces the cost of errors by avoiding duplicate effort from undetected code clones with defects that have been previously fixed.

Developers often duplicate code for quick code reuse. A piece of duplicated code is also called a code clone. Quite often upon making changes to one piece of code, the same change ought to be applied to its cloned copies as well. Today, during code review, the reviewer can only figure out if the same change needs to be applied to its cloned copies by his/her knowledge of the code base in mind. It is difficult to guarantee that all clone copies are considered. The code verification system solves this by searching the changed code snippets against a code clone search engine that indexes the source code of the current code base or in a more expanded scope of code bases and automatically informs code reviewers to check the duplicated copies.

Today it is difficult for a code reviewer to understand the architecture level difference between two versions of the source code during code reviews. Existing tools do a good job of pointing out text-level differences, such as added and removed lines, words, or characters, but because software code can be constructed in so many ways these tools do not provide any kind of higher level view. There are also good existing tools for displaying architectural information about a current version of the code, such as class viewers, namespace viewers, and so forth. However, these tools have no facility for comparing two versions of the software code and helping the developer to visualize what has changed. This further makes the code reviewer have difficulty figuring out if architecture level code refactoring would be helpful.

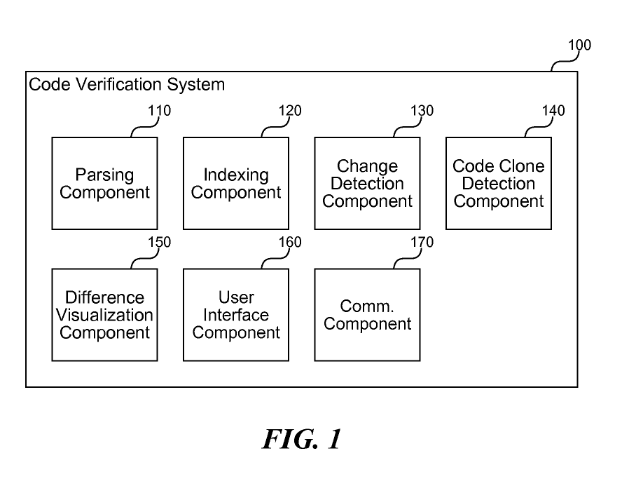

FIG. 1 is a block diagram that illustrates components of the code verification system, in one embodiment. The system 100 includes a parsing component 110, an indexing component 120, a change detection component 130, a code clone detection component 140, a difference visualization component 150, a user interface component 160, and a communication component 170. Each of these components is described in further detail herein.

The parsing component 110 parses software code written in a programming language to identify information related to the software code for indexing. Although referred to simply as parsing herein, this process may include typical processes involved with compiling software code including parsing, lexical analysis, optimization, and so forth. The parsing component 110 may identify variable names, blocks of code, language keywords (e.g., “if”, “then”, and “while”), variable declarations, class definitions, and any other code features. The parsing component 110 may include plug-in modules or other sub-components for handling various programming languages. The parsing component 110 can operate on a large body of checked in code as well as a local body of code actively being edited by a developer. In some embodiments, the parsing component 110 parses new text entered as the user types and/or pauses (e.g., MICROSOFT™ INTELLISENSE™).

The indexing component 120 indexes software code information identified during parsing to provide fast lookup and matching of code information. The component 120 may create an index of a large body of code or of multiple bodies of code and receive queries that determine whether there exists known code that matches input code. For example, the index may contain code for a large project and the system 100 may submit queries based on what the developer is currently typing. The system 100 may also query based on a subset of code around the developer's current editing location to identify code clones related to the current location. The indexing component 120 may operate locally on a developer's computing device or on a server accessible from the developer's computing device. The indexing component 120 operates in an incremental way to incorporate new code changes or additional code bases as they are identified over time.

The change detection component 130 detects a current change by a developer to an identified range of software code. The component 130 may be integrated into an IDE that the developer uses for editing software code. In some embodiments, the change detection component 130 monitors typing and other developer input to detect that the developer is making a change to software code. The detected change may include adding, deleting, or updating software code in a particular source file or through one or more visual editing tools. The change detection component 130 identifies one or more code ranges and submits the ranges to the code clone detection component 140 for comparison to an index of known code clones.

The code clone detection component 140 identifies one or more code clones related to the identified range of a detected change made by the software developer. The system may submit code or a range of code around the developer's currently location to the index component 120 to identify similar or matching code ranges in the same or other software projects. The code clone detection component 140 may operate locally to identify clones stored on the developer's computing device or may operate at a broader level, such as within a company on a server or on a public Internet server that provides indexing of source code for multiple software projects. In some embodiments, the code clone detection component 140 identifies a beginning and end of a code clone based on granularity information (e.g., block level, function level, module level similarities) or based on a determined size around the current code location (e.g., current location +/−100 characters). Clones can be defined and identified in a variety of different ways, and the description herein is not intended to limit the system 100 to any one particular method. In particular, different programming languages will vary in the granularity of source code that is suitable for identifying code clones.

The difference visualization component 150 creates an architectural model of source code and compares the architectural model with other architectural models to identify architectural differences. The component 150 may receive as input two versions of the same source code (e.g., one from today and one from last week) and compare the two versions to display architectural differences to a software developer or architect. The component 150 may also compare different bodies of code to help developers visualize architectural similarities and differences. In some embodiments, an IDE invokes the difference visualization component 150 during a code review process so that a developer can easily identify differences between checked in code and new code at an architectural level. Software code can be factored and refactored into a variety of designs and architectures. Often source code that varies significantly at the text level varies very little at the architectural level or vice versa. For example, if a developer renamed every variable in a program, the text would hardly match at all but the architecture would be the same (e.g. same classes, relationships between classes, and so on).

The user interface component 160 provides identified code clones and identified architectural differences to a developer. The user interface component 160 may include a graphical user interface (GUI), programmatic application programming interface (API), or other interface for providing the information to developers. The component 160 may operate as a part of an IDE or as a plug-in integrated into an extensible IDE to provide clone identification as a user edits software code and to provide architectural comparisons upon request. In some embodiments, the system 100 operates as part of a code review process for reviewing source code changes and provides a GUI or other interface during the code review process to display code clones and architectural differences related to present changes to the developer and/or reviewer. The component 160 may also provide web, mobile, or other interfaces appropriate for visualizing the information. In some embodiments, the user interface component 160 includes a notification subcomponent that provides notification to code owners or other developers upon detection that cloned code upon which their software code is based has changed. This allows the developers to fix problems in their code that have been identified by other developers in related code, whether the developers are aware of each other or the sharing of code.

The communication component 170 is an optional component that provides communication between other components of the system 10 when the system 100 is distributed. Although the system can operate wholly on a single developer's client computing device, some users will find additional value by applying the system 100 to much larger bodies of code. The system 100 allows individual components to be placed on one or more servers both to access larger bodies of code than what is available on a single developer's computing device and to offload resource consumption from the developer's computing device used to perform the functions of the system 100. For example, the code clone detection and architectural modeling may be provided by a server that has access to multiple versions of code and to multiple code bases. In such cases, an individual developer's IDE may connect through the communication component 170 to the server to receive information for assisting the developer. The communication component 170 may use a variety of common networking protocols and networks, such as transmission control protocol (TCP) over a local area network (LAN) or the Internet. The system may also leverage cloud-computing resources to distribute processing, storage, or other functions to scalable cloud-based servers, such as those provided by MICROSOFT™ WINDOWS™ AZURE™.

The computing device on which the code verification system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

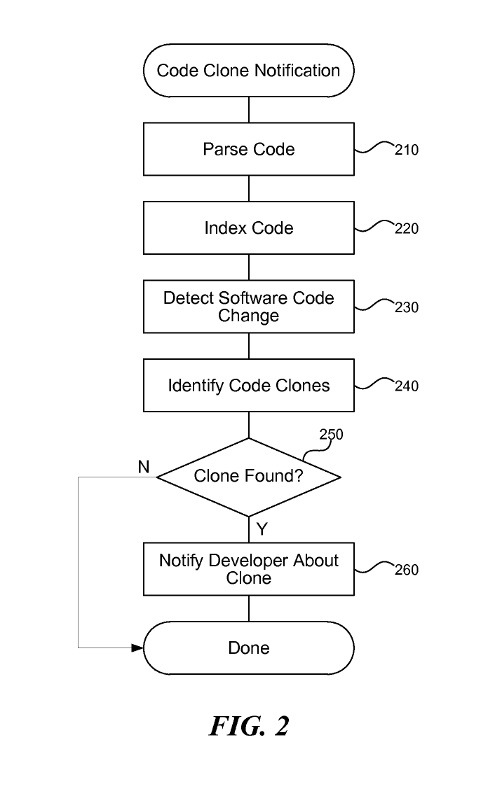

FIG. 2 is a flow diagram that illustrates processing of the code verification system to notify a software developer that software code exists related to software code the developer is modifying, in one embodiment. Beginning in block 210, the system parses a software code base to identify information related to the software code. The system may identify language features, blocks of code, variable information, class and other data structure information, function information, and so forth. The system provides the parsed information to an index for querying as users modify the software code. The system also parses source code the developer is currently working on to compare to previously parsed software code in the index.

Continuing in block 220, the system indexes the parsed software code base to provide quick identification of matching sections of software code. The index may contain software code from a developer's computing device or a broader code base encompassing potentially many developers' contributions to potentially many software projects. The system provides querying and searching functionality based on the index to identify code clones related to a current range of software that the developer is working on. The system may update the index as developers check in software code to a code management system or at other significant milestones. The system may also provide a local index at the developer's computing device for looking up related information as the developer edits source code.

The preceding two steps may occur on an ongoing basis and at an earlier time or separate server than the following steps. For example, the system may provide a code clone indexing service that continuously identifies and indexes software code changes. A separate service running on the developer's computing device may identify changes made by the developer and query the index service to identify related software code. Alternatively or additionally, the system may provide an index service on the developer's computing device for identifying related code on the same computing device.

Continuing in block 230, the system detects a software code change provided by a developer editing software code. The system may detect typing by the developer to fix a defect identified in the software code. As the user types, the system may submit changes in a query against the index to identify related code to the code the developer is working on. The system may also provide an API to an IDE or other software program through which the IDE can provide information to the system describing software changes and can receive information about code clones in response. In some embodiments, a developer may select a particular block of code and select an option (e.g., “Find Similar Code”) to identify code clones related to the selected block of code.

Continuing in block 240, the system identifies any code clones related to the code change provided by the developer. The system may consult the index and provide a portion of the code surrounding the code change or a previous version of the code before the change to help identify related code. The code clones may exist in the current code base, in related code bases, or in completely unrelated code bases that happen to share a particular range of software code. It is common for blocks of code to be reused by developers at both a macro and micro level. In some cases, a developer may reuse a particular function or program loop, and in other cases, a developer may reuse entire modules or classes. The system can identify clones at a variety of levels and granularities. In some embodiments, the system provides configuration parameters that a user or application can modify to configure the level at which clones are identified.

Continuing in decision block 250, if the system identified at least one clone then the system continues at block 260, else the system completes. The system may receive a list of clones identified from a clone index server or from a local index running on the developer's computing device. The list may include information describing the clone such as a storage location of the clone's source code (e.g., a uniform resource locator (URL) or file path), file name information, line number information, a developer associated with the clone, and so forth.

Continuing in block 260, the system notifies the software developer that at least one clone exists so that the developer can determine whether to apply the detected change to identified clones. The system may provide a popup message, tooltip, docked list in an IDE, or other user interface for displaying identified clones to the developer. The system may determine a threshold of clones to display (e.g., 10) or may provide user interface controls for navigating between clones. In some cases, the developer may not have access to modify the clones, and the system may provide contact information for the developer to notify other developers of the code change. The system may also provide automated notification to other developers, such as an email message, that are responsible for code clones. The notification may include information describing the change, identifying the developer that made the change, and any information provided by the developer describing a motivation for the change. After block 260, these steps conclude.

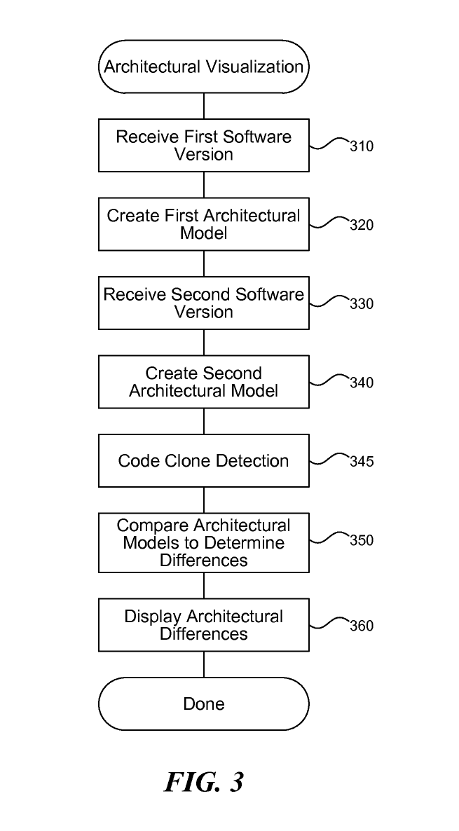

FIG. 3 is a flow diagram that illustrates processing of the code verification system to display architectural level changes to a software developer related to changes in software code, in one embodiment. Beginning in block 310, the system receives a first version of software code that includes one or more architectural features. The software code may include a code base that is part of a project the developer is working on or other code bases. The developer may identify two versions of software code for which the developer wants to receive an architectural comparison. In some embodiments, the system provides a user interface through which the developer can request an architectural comparison.

Continuing in block 320, the system creates a first architectural model that provides a conceptual visualization of the received first version of the software code. The model may include classes, modules, namespaces, and other programming language and environmental features that describe the software code at an architectural level. The model may include one or more in-memory data structures and displayed visualizations for viewing the architecture of the first version of the software code. The system may create and store architectural models of previously stored software code (e.g., check-ins, releases, or other milestones).

Continuing in block 330, the system receives a second version of the software code that includes one or more architectural features. The second version may be a subsequent version of the same code base or a related code base for which the developer wants to identify architectural differences. The developer may identify the second software version or the system may automatically infer the second software version to be the version of source code on which the developer is currently working. In some embodiments, the system automatically identifies the first and second software versions as part of a process, such as integrating a code branch in a source management system or checking in the software code.

Continuing in block 340, the system creates a second architectural model that provides a conceptual visualization of the received second version of the software code. Like the first architectural model, the second model highlights architectural constructs of the second version of the software code. The models may include performance information derived from unit tests or other benchmarks run on each version of the software code.

Continuing in block 345, the system conducts code clone detection between the two versions of the code base. The raw detection results could be a set of cloned function/snippet pairs where one function/snippet comes from the first version of the code base and the other function/snippet comes from the second version of the code base. The raw clone pairs between the two versions of the code bases are further used in the next step to identify architectural level clones. Continuing in block 350, the system compares the first architectural model and second architectural model, as well as the raw clone pair information, to identify one or more differences between the two models. Differences may include added architectural features, removed architectural features, identifying code similarities (e.g., percentage of code shared) based on the code clone detection result, identifying refactoring that has occurred, and so forth. The architectural comparison may also identify statistics describing each model such as clones used within the model, performance characteristics of the model, and so forth. The system may compare this information to show an increase or decrease in performance or clone use. The comparison may also identify objects that have not changed, as this can be useful information for the developer, too.

Continuing in block 360, the system displays the architectural differences between the software code versions in a visual display that illustrates the changes to the developer. The display may include block diagrams that show major code components with arrows representing dataflow between the components or other visualizations that are helpful for succinctly communicating the changes at an architectural level. In some embodiments, the system may display statistics over some displayed components that indicate an amount of change or other differences. After block 360, these steps conclude.

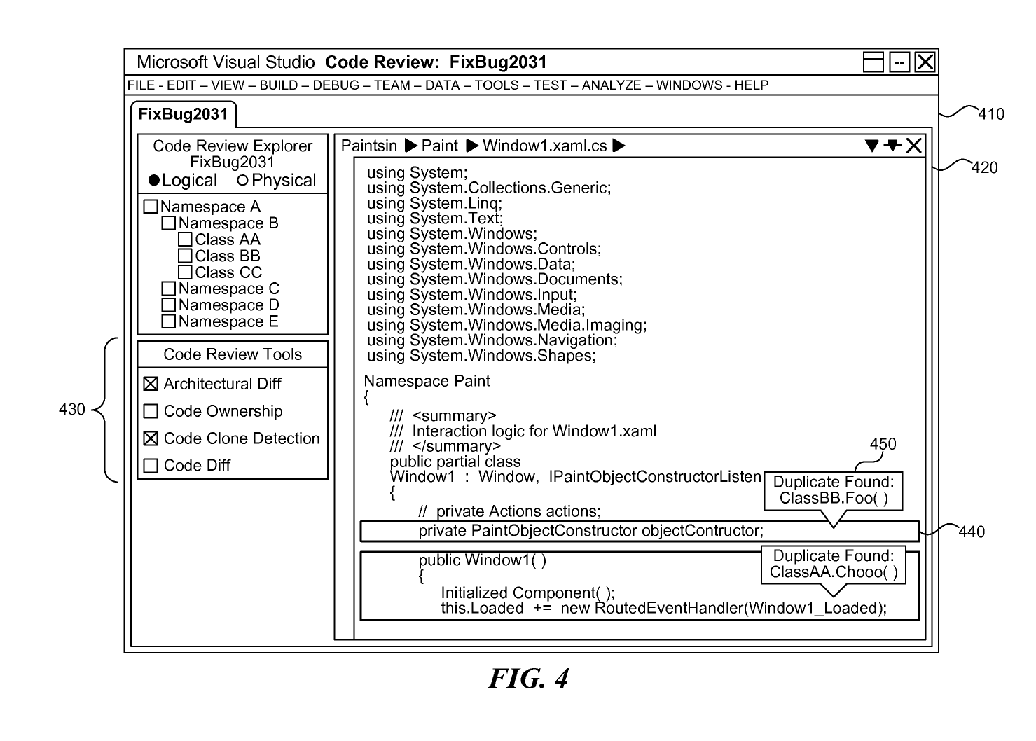

FIG. 4 is a display diagram that illustrates a user interface displayed by the code verification system for notifying a software developer about code clones, in one embodiment. The display includes an IDE window 410 that provides one or more tools for editing and managing software code. The IDE window 410 includes a code window 420 that displays a particular software code source file that the developer is currently viewing and/or editing. The IDE window 410 also includes a set of code review options 430 that includes an option for detecting code clones. The code window 420 includes multiple identified clones. For example, the code window 420 includes a first identified code range 440 that is highlighted and an identified code clone displayed in a popup window 450. The popup window 450 provides information about the clone, such as the clone's name and a link to open a source file associated with the clone. The developer can use this information to view the code clone. In some cases, the clone may contain code that is more up to date than the developer's version, in which case the developer may copy the changes. In other cases, the developer's changes also belong in the clone, and the developer may modify the clone or notify the clone owner to modify the clone.

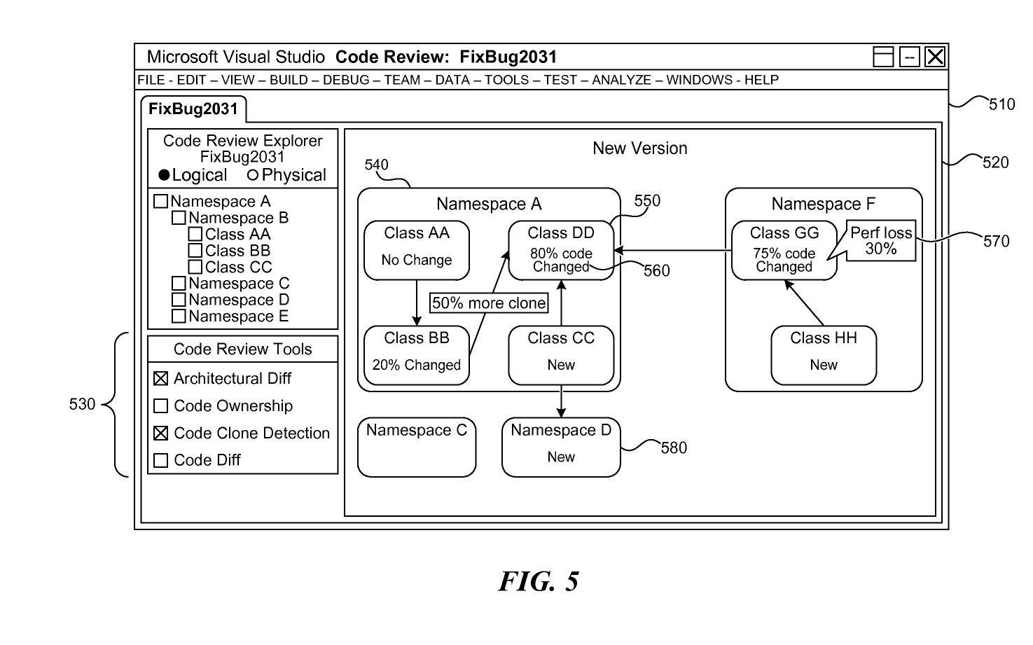

FIG. 5 is a display diagram that illustrates a user interface displayed by the code verification system for providing a visualization of architectural changes to software code to a software developer, in one embodiment. The display includes an IDE window 510 that provides one or more tools for editing and managing software code. The IDE window 510 includes an architectural comparison window 520 that displays the visualizations described herein related to a software project selected by the developer. The IDE window 510 also includes a set of code review options 530 that includes an option for displaying architectural differences between code versions. The architectural comparison window 520 includes multiple blocks that identify architectural features and changes. For example, the architectural comparison window 520 includes a first namespace 540. The namespace 540 includes a class 550. The class 550 provides statistical information 560 that indicates that 80% of the class code has changed between the two versions. Another class provides an indication 570 that the class has lost 30% of its measured performance between the code versions. Another namespace 580 indicates that the namespace is new and is not present in the first version of the software code. The system displays these and other changes so that the developer receives a high-level view of what code changes mean in addition to the raw changes to the text.

In some embodiments, the code verification system assists developers in multiple stages of reviewing code. In the first stage of self-review, the system provides input to the developer as the developer modifies software code about code clones related to that code and/or architectural changes that the developer is making to the software code. In a second stage of review, a reviewer, such as a peer of the developer or the developer's manager, uses the system to view the software developer's changes, both in terms of usage of or changes to code clones and architectural changes made by the developer. At an even higher level, team architects or others responsible for large bodies of code may use the system to view individual changes or changes that occur between major points in the code history (e.g., milestones or releases) to visualize the nature of the changes.

In some embodiments, the code verification system can be used to prevent code reuse. Software code often includes copyright or other restrictions that a company or other entity may not want to incur in their software code. The system can be used to identify code within a software project that matches code in a project that the developer ought to avoid, so that the developer or other review can remove the offending code. Similarly, the company can use the system to ensure that identified vulnerabilities are fixed across the company's entire set of code bases. The system allows wide-scale analysis of code similarities and reuse on a level not previously available.

From the foregoing, it will be appreciated that specific embodiments of the code verification system have been described herein for purposes of illustration, but that various modifications may be made without deviating from the spirit and scope of the invention. Accordingly, the invention is not limited except as by the appended claims.

I/We claim:

1. A computer-implemented method for notifying a software developer that software code exists related to software code the developer is modifying, the method comprising:
parsing a software code base to identify information related to the software code;
indexing the parsed software code base to provide quick identification of matching sections of software code;
detecting a software code change provided by a developer editing software code;
identifying any code clones related to the code change provided by the developer;
upon detecting that a clone was identified, notifying the software developer that at least one clone exists so that the developer can determine whether to apply the detected change to identified clones,
wherein the preceding steps are performed by at least one processor.

2. The method of claim 1 wherein parsing the software code base comprises identifying at least one of language features, blocks of code, variable information, class and other data structure information, and function information.

3. The method of claim 1 wherein parsing the software code base comprises parsing source code the developer is currently working on to compare to previously parsed software code in the index.

4. The method of claim 1 wherein indexing the software code comprises indexing software code from the developer's computing device and at least one other code base.

5. The method of claim 1 wherein indexing the software code comprises providing querying and searching functionality based on the index to identify code clones related to a current range of software that the developer is working on;

6. The method of claim 1 wherein indexing the software code comprises updating the index as developers check in software code to a code management system or at other significant milestones.

7. The method of claim 1 wherein parsing and indexing the software code occur on an ongoing basis at a code base indexing server that continuously identifies and indexes software code changes.

8. The method of claim 1 wherein detecting the software code change comprises detecting typing by the developer to fix a defect identified in the software code, and as the user types, submitting changes in a query against the index to identify related code clones to the code the developer is working on.

9. The method of claim 1 wherein detecting the software code change comprises detecting that the developer selected a particular block of code and selected an option to identify code clones related to the selected block of code.

10. The method of claim 1 wherein identifying code clones comprises querying the index and providing a portion of the code surrounding the code change to identify related code.

11. The method of claim 1 wherein identifying code clones comprises identifying clones in the same or different code bases from the code base the developer is working on.

12. The method of claim 1 wherein notifying the developer comprises providing a user interface message that identifies the clones within an integrated development environment (IDE).

13. The method of claim 1 wherein notifying the developer comprises providing an additional notification to another developer associated with an identified code clone.

14. A computer system for augmenting software code reviews with code clone identification and architectural change visualization, the system comprising:
a processor and memory configured to execute software instructions embodied within the following components;
a parsing component that parses software code written in a programming language to identify information related to the software code for indexing;
an indexing component that indexes software code information identified during parsing to provide fast lookup and matching of code information;
a change detection component that detects a current change by a developer to an identified range of software code;
a code clone detection component that identifies one or more code clones related to the identified range of a detected change made by the software developer;
a difference visualization component that creates an architectural model of source code and compares the architectural model with other architectural models to identify architectural differences; and
a user interface component that provides identified code clones and identified architectural differences visually to the developer.

15. The system of claim 14 wherein the change detection component is associated with an integrated development environment (IDE) that the developer uses for editing software code, and wherein the change detection component monitors typing and other developer input to detect that the developer is making a change to software code and submit one or more code ranges to the code clone detection component for comparison to an index of known code clones.

16. The system of claim 14 wherein the code clone detection component operates locally on the computer system to identify clones stored on the developer's computing device.

17. The system of claim 14 wherein the code clone detection component operates at a remote server to identify code clones across multiple code bases.

18. The system of claim 14 wherein the difference visualization component receives as input two versions of the same source code and conducts code clone detection between versions of the source code and compares the two versions to display architectural differences to the software developer based on the clone detection result.

19. A computer-readable storage medium comprising instructions for controlling a computer system to display architectural level changes to a software developer related to changes in software code, wherein the instructions, upon execution, cause a processor to perform actions comprising:
receiving a first version of software code that includes one or more architectural features;
creating a first architectural model that provides a conceptual visualization of the received first version of the software code;
receiving a second version of the software code that includes one or more architectural features;
creating a second architectural model that provides a conceptual visualization of the received second version of the software code;
detecting code clones between two versions of the code bases;
comparing the first architectural model and second architectural model to identify one or more architectural level differences between the two models based on the code clone detection result;
displaying the architectural differences between the software code versions in a visual display that illustrates the changes to the developer.

20. The medium of claim 19 wherein the received second version is a subsequent version of the same code base or a related code base for which the developer wants to identify architectural differences, and wherein the models include performance information related to each version of the software code or other quality information related to each version of the software code.
